(19) United States
(12) Patent Application Publication
(10) Pub. No.: US 2012/0041883 A1
(43) Pub. Date: Feb. 16, 2012

(54) INFORMATION PROCESSING APPARATUS, INFORMATION PROCESSING METHOD AND COMPUTER READABLE MEDIUM

(75) Inventors: Satomi MIZUNO, Kanagawa (JP); Masakazu FUJIMOTO, Tokyo (JP); Eiji NISHIKAWA, Tokyo (JP)

(73) Assignee: FUJI XEROX CO., LTD., Tokyo (JP)

(21) Appl. No.: 13/045,564

(22) Filed: Mar. 11, 2011

(30) Foreign Application Priority Data
Aug. 16, 2010 (JP) 2010-181531

(51) Int. Cl. G06Q 10/00

(52) U.S. Cl. 705/301

(57) ABSTRACT

An information processing apparatus includes a reception module, a determination module, a required information conveyance amount extraction module, an actual information conveyance amount extraction module, and a presentation module. The reception module receives business contents of a subject business. The determination module determines whether the subject business is irregular business by comparing the business contents with predetermined regular business contents. The required information conveyance amount extraction module extracts a required information conveyance amount required to perform the irregular business from attribute information conveyance amount correspondence information when it is determined by the determination module that the business contents is the irregular business. The actual information conveyance amount extraction module extracts an actual information conveyance amount of a person who performs the subject business based on activity information of the person. The presentation module presents guidance by comparing the required information conveyance amount with the actual information conveyance amount.

### CROSS-REFERENCE TO RELATED APPLICATIONS

This application is based upon and claims priority under 35 USC 119 from Japanese Patent Application No. 2010-181531, filed Aug. 16, 2010.

### BACKGROUND

### TECHNICAL FIELD

The present invention relates to an information processing apparatus, an information processing method and a computer readable medium.

### SUMMARY OF THE INVENTION

According to an aspect of the invention, an information processing apparatus includes a reception module, a determination module, a required information conveyance amount extraction module, an actual information conveyance amount extraction module, and a presentation module. The reception module receives business contents of a subject business. The determination module determines whether the subject business is irregular business by comparing the business contents received by the reception module with a predetermined regular business contents. The required information conveyance amount extraction module extracts a required information conveyance amount required to perform the irregular business from attribute information conveyance amount correspondence information, in which an attribute of the subject business and the required information conveyance amount are stored in correspondence to each other, based on the attribute of the subject business when it is determined by the determination module that the business contents is the irregular business. The actual information conveyance amount extraction module extracts an actual information conveyance amount of a person in charge who performs the subject business based on activity information that is a record of activities of the person in charge. The presentation module presents guidance which is required to perform the subject business by comparing the required information conveyance amount extracted by the required information conveyance amount extraction module with the actual information conveyance amount extracted by the actual information conveyance amount extraction module.

### BRIEF DESCRIPTION OF THE DRAWINGS

Exemplary embodiments of the invention will be described in detail based on the following figures, wherein:

FIG. 1 is a diagram illustrating the configuration of a conceptual module according to a configuration example according to an exemplary embodiment of the invention;

FIG. 2 is an explanatory diagram illustrating an example of a business flow;

FIG. 3 is an explanatory diagram illustrating an example of the relationship between a minimum amount and a trust amount;

FIG. 4 is an explanatory diagram illustrating an example of a data structure of a media weight value table;

FIG. 5 is an explanatory diagram illustrating an example of a data structure of an activity log table;

FIG. 6 is an explanatory diagram illustrating an example of a data structure of a communication log table;

FIG. 7 is an explanatory diagram illustrating an example of a data structure of a business flow data table;

FIG. 8 is an explanatory diagram illustrating an example of a data structure of a guide condition data table;

FIG. 9 is a flowchart illustrating a processing example according to an exemplary embodiment of the invention;

FIG. 10 is a flowchart illustrating a processing example by a regular/irregular determination module according to an exemplary embodiment of the invention;

FIG. 11 is a flowchart illustrating a processing example by a trust amount determination module according to an exemplary embodiment of the invention;

FIG. 12 is a flowchart illustrating a processing example by a worker status determination module according to an exemplary embodiment of the invention;

FIG. 13 is a flowchart illustrating a processing example by a guide evaluation module according to an exemplary embodiment of the invention;

FIG. 14 is a flowchart illustrating a processing example by a guide correction module according to an exemplary embodiment of the invention;

FIG. 15 is a flowchart illustrating a processing example by a guide correction module according to an exemplary embodiment of the invention; and

FIG. 16 is a block diagram illustrating an example of a computer hardware configuration that is realized in an exemplary embodiment of the invention.

### DETAILED DESCRIPTION

Exemplary embodiments of the invention will be described with reference to the accompanying drawings.

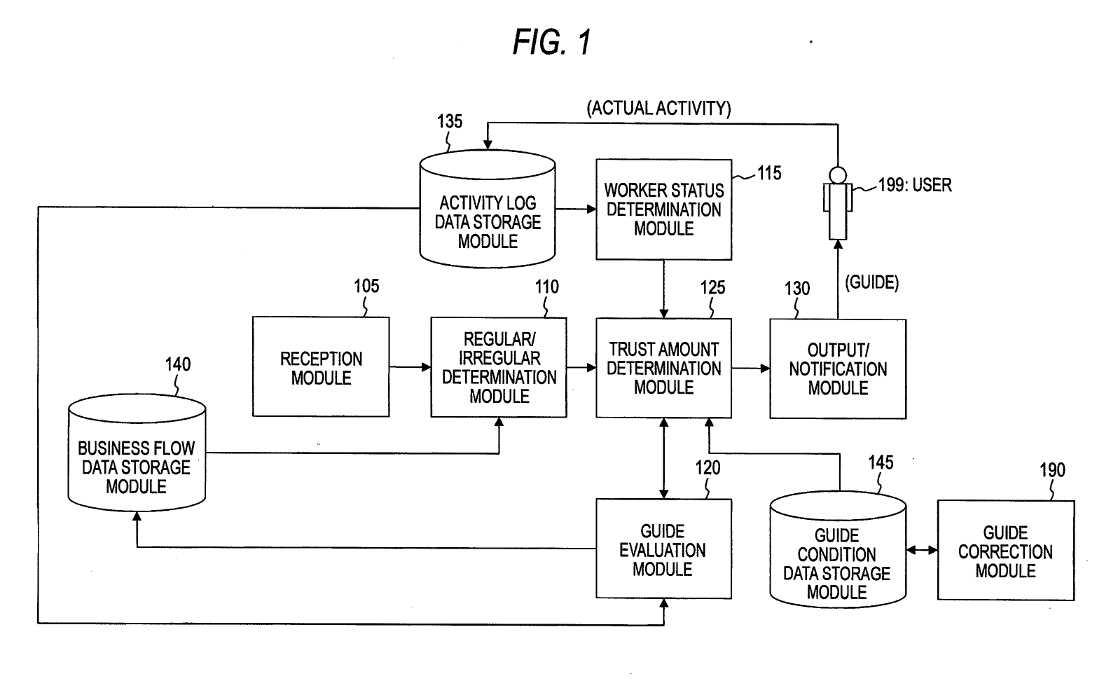

FIG. 1 is a diagram illustrating the configuration of a conceptual module according to a configuration example according to an exemplary embodiment of the invention.

The term “module”, as used herein, generally means a logically separable software (computer program) or hardware component or the like. Accordingly, in an exemplary embodiment of the invention, the module means not only a module in a computer program but also a module in a hardware configuration. Because of this, in an exemplary embodiment of the invention, computer programs that function as the modules (a program for executing respective procedures in a computer, a program for making a computer function as respective means, and a program for realizing the respective functions in a computer), systems and methods will also be explained. However, although the wordings “memorize”, “store”, and the equivalents thereof are used for convenience in explanation, they mean storing in a storage device or controlling to store in a storage device in the case when a computer or a program is exemplified. Also, a module may correspond to a function in a one-to-one manner, and in mounting, one module may be configured as one program, plural modules may be configured as one program, or conversely, one module may be configured as plural programs. Also, the plural modules may be executed by one computer, and in a distributed or parallel environment, one module may be executed by plural computers. In this case, one module may be included in another module. Also, hereinafter, the term “connection” may be used as not only a physical connection but also a logical connection (data exchange, instruction, reference relations between data, and the like). The wording “predetermined” means determination before the subject processing, and in an exemplary embodiment of the invention, it is determined in accordance with the situation or condition at the time not only before the processing according to an exemplary embodiment of the invention starts but also before the subject processing even after the processing according to an exemplary embodiment of the invention starts or in accordance with the situation or condition up to that time.

Also, the term “system” or “apparatus” includes a configuration realized by one computer, piece of hardware, apparatus, or the like in addition to a configuration in which plural computers, piece of hardware, apparatuses, or the like are connected by a communication means such as a network (that includes a communication connection in a one-to-one manner) or the like. The terms “apparatus” and “system” are used as a wording having the same meaning. Of course, the term “system” does not include a mere social “structure” (social system) that is an artificial agreement.

Also, in the case of executing processes by respective modules or executing plural processes in a module, the subject information is read from a storage device for each process, and the result of the process is written in the storage device after the process is executed. Accordingly, with respect to the reading from the storage device before the process and the writing in the storage device after the process, the explanation thereof may be omitted. Here, the storage device may include a hard disk, a RMM (Random Access Memory), an external storage medium, a storage device through a communication line, a register in a CPU (Central Processing Unit), and the like.

An information processing apparatus according to an exemplary embodiment of the invention, as illustrated in an example of FIG. 1, includes a reception module 105, a regular/irregular determination module 110, a worker status determination module 115, a guide evaluation module 120, a trust amount determination module 125, an output/notification module 130, an activity log data storage module 135, a business flow data storage module 140, a guide condition data storage module 145, and a guide correction module 190. In this case, a person in charge is called a user, a person, an employee, a worker, or the like, in accordance with the context.

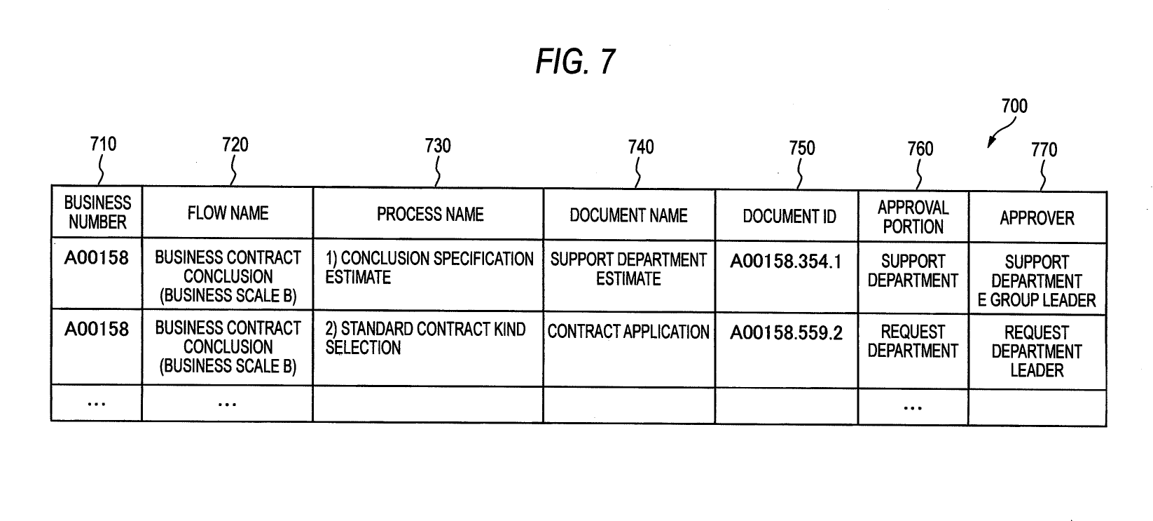

The business flow data storage module 140 is connected to the regular/irregular determination module 110 and the guide evaluation module 120. The business flow data storage module 140 stores information data, such as documents required in a business process, a department in charge, participators, and the like. For example, the business flow data storage module 140 stores a business flow data table 700. FIG. 7 is an explanatory diagram illustrating an example of a data structure of a business flow data table 700. The business flow data table 700 includes a business number section 710, a flow name section 720, a process name section 730, a document name section 740, a document ID section 750, an approval department section 760, and an approver section 770. The business number section 710 stores a business code (for example, business number) that consistently identifies the business in an exemplary embodiment of the invention. The flow name section 720 stores the name of the business process (for example, business contract conclusion (contract scale B)). The process name section 730 stores the name of a process (for example, estimation of conclusion specification) which is an individual business in the business process. The document name section 740 stores the names of documents (for example, an estimate of a supply department) that are required in the business. The document ID section 750 stores document codes (for example, document IDs) that consistently identify the documents in an exemplary embodiment of the invention. The approval department section 760 stores the names of approval departments (for example, supply departments) as the department in charge in the business. The approver section 770 stores the name of an approver (for example, a group leader of a supply department E) as a participator in the business.

The reception module 105 is connected to the regular/irregular determination module 110. The reception module 105 receives the business contents of the subject business based on a user's operation of a keyboard, a mouse, or the like. The business contents may be, for example, documents required for the business. In addition, the business contents may be business connections, the appointed dates, amounts of money, and the like. Also, in addition to the business contents, the reception module 105 may receive the business kind of the subject business (for example, a contract conclusion business process or the like). The reception module 105 delivers the received business kind or the business contents to the regular/irregular determination module 110.

The regular/irregular determination module 110 is connected to the reception module 105, the trust amount determination module 125, and the business flow data storage module 140. The regular/irregular determination module 110 determines whether the subject business is the irregular business by comparing the business contents received by the reception module 105 with predetermined typical business contents. Here, the predetermined typical business contents may be, for example, required documents in regular business. In this case, if the required documents received by the reception module 105 and the required documents in the typical business are different from each other, it is determined that the subject business is the irregular business. The determination of whether the business is the irregular business may be performed by comparing the document names. Also, if the received required documents are insufficient (the required documents are not fully prepared) in comparison to the required documents in the typical business, it is determined that the documents are different from each other and thus the subject business is the irregular business. In addition, the business contents to be compared with each other may be business connections, the appointed dates, amounts of money, and the like.

Also, the regular/irregular determination module 110 extracts the business in the typical business kind that corresponds to the business kind that is received by the reception module 105. Also, the regular/irregular determination module 110 determines whether the subject business is the irregular business by comparing the business contents received by the reception module 105 with the business contents in the extracted business.

For example, the regular/irregular determination module 110 extracts the business flow data table 700 as the predetermined typical business contents stored in the business flow data storage module 140. Also, the regular/irregular determination module 110 compares the document name stored in the document name section 740 of the business flow data table 700 with the document name that is the business contents received by the reception module 105. The regular/irregular determination module 110 determines that the business is the regular business if the document names coincide with each other, while it determines that the business is the irregular business if the document names do not coincide with each other.

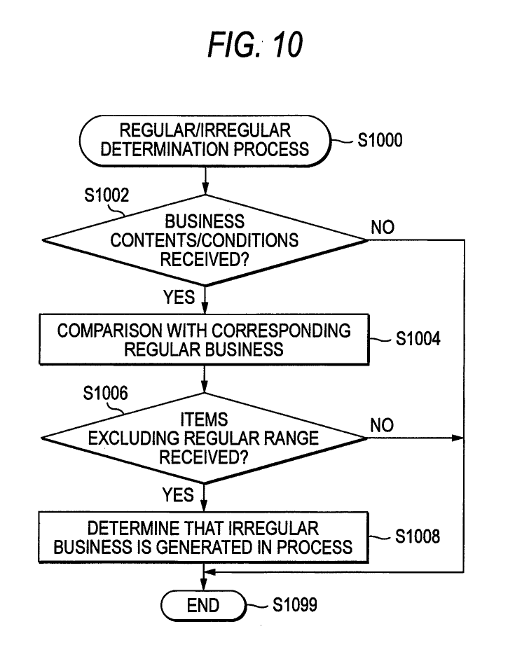

In this case, the processing of the regular/irregular determination module 110 will be described later using a flowchart exemplified in FIG. 10.

The activity log data storage module 135 is connected to the worker status determination module 115 and the guide evaluation module 120. The activity log data storage module 135 stores activity information (hereinafter referred to as “activity log data”) that is the record of activities obtained by acquiring the results of activities or communication log data (which may also be activity log data and communication log data) obtained by acquiring the results of communication such as by electronic mail.

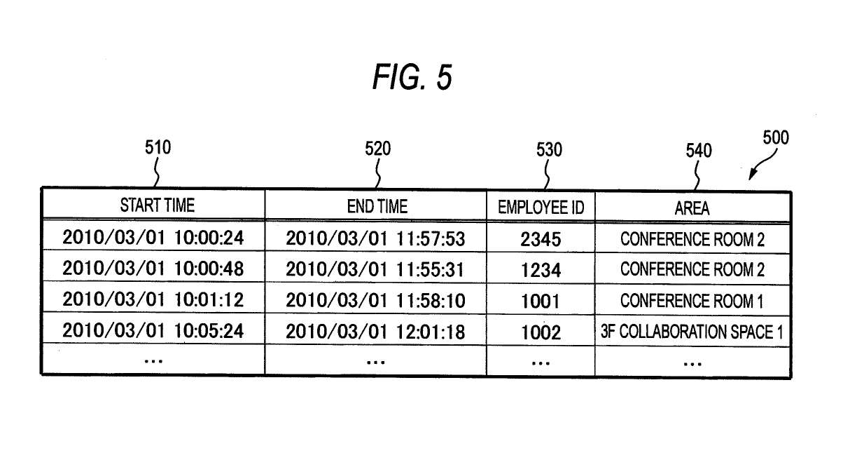

The activity log data storage module 135 stores, for example, an activity log table 500 as the activity log data. FIG. 5 is an explanatory diagram illustrating an example of a data structure of the activity log table 500. The activity log table 500 includes a start time section 510, an end time section 520, an employee ID section 530, and an area section 540. The start time section 510 stores the date a user of the employee ID section 530 enters a room of the area section 540. The end time section 520 stores the date a user of the employee ID section 530 leaves a room of the area section 540. The employee ID section 530 stores user information (for example, an employee ID) that consistently identifies the subject user in an exemplary embodiment of the invention. The area section 540 stores area information that consistently identifies the subject area in an exemplary embodiment of the invention. For example, the area information may be the name of a conference room. Also, the activity log data that the activity log table 500 stores may include a record of indoor activities or a record of outdoor activities. The indoor activity log data may be, for example, the result of detecting the RFID (Radio Frequency Identification) that a user 199 possesses through a position detection device. Also, the outdoor activity log data may be, for example, coordinate information such as GPS (Global Positioning System) that a user 199 possesses.

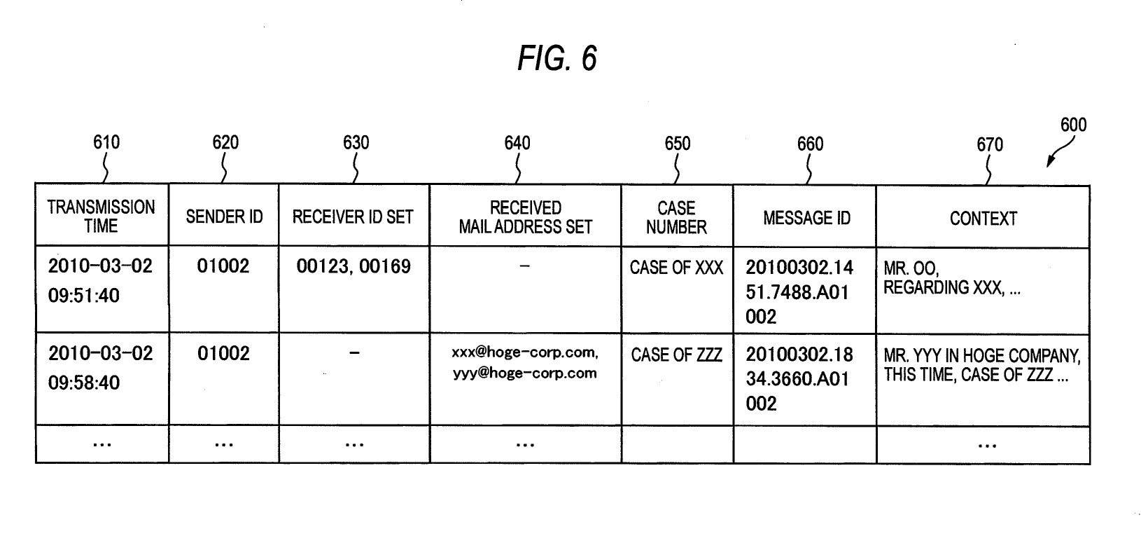

The activity log data storage module 135 stores, for example, a communication log table 600 as communication log data. FIG. 6 is an explanatory diagram illustrating an example of a data structure of the communication log table 600. The communication log table 600 includes a transmission time section 610, a sender ID section 620, a receiver ID set section 630, a received mail address set section 640, a case name section 650, a message ID section 660, and a text section 670. The transmission time section 610 stores the date an electronic mail is transmitted. The sender ID section 620 stores user information (for example, an employee ID) that consistently identifies the user who transmits the electronic mail in an exemplary embodiment of the invention. The receiver ID set section 630 stores user information that indicates a user who receives the electronic mail. In this case, the receiver ID set section 630 may store information on a plurality of users. The received mail address set section 640 stores a mail address of a user who receives the electronic mail. In this case, the received mail address set section 640 may store a plurality of mail addresses. The case name section 650 stores the case name of the electronic mail. The message ID section 660 stores a message ID that consistently identifies the electronic mail in an exemplary embodiment of the invention. The text section 670 stores the text that is the contents of the electronic mail.

By using the communication log data, the date the electronic mail exchanged between the users is transmitted, the size (capacity) of the text, and the like, may be extracted.

The worker status determination module 115 is connected to the trust amount determination module 125 and the activity log data storage module 135. The worker status determination module 115 extracts an actual communication amount of a person in charge who performs the subject business based on the activity log data of the person in charge. Specifically, the worker status determination module 115 determines the actual communication amount by individuals based on the activity log data or communication log data (which may also be the activity log data and the communication log data) stored in the activity log data storage module 135.

Also, the worker status determination module 115 may increase or decrease the actual communication amount according to the kind of activity of the person in charge.

In the case of the irregular business, in understanding and trusting the exceptional contents, there are more than a few shaking in grasping of the business circumstances/characteristics by individual relationships and in determination by serious correspondence.

Accordingly, in calculating the actual communication amount, weighting may be performed according to the kinds of activities. The weight value for weighting adapts the weight value that is prescribed based on the business and organization since the transfer efficiency of communication differs according to the characteristics of the business and the organization.

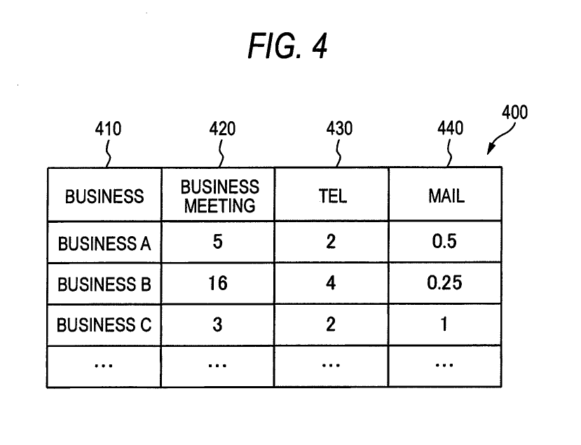

As the kinds of activities, for example, there are meeting with another person in charge, phone call, an electronic mail, and the like. As a method of increasing or decreasing the actual communication amount, for example, the kinds of activities and the weight values may be pre-stored in correspondence to each other. As an example of storing the kinds of activities and the weight values in correspondence to each other, as the media weight value table 400 as exemplified in FIG. 4, a combination of the business and the activity kinds may be stored in correspondence to the weight values. FIG. 4 is an explanatory diagram illustrating an example of a data structure of a media weight value table 400. The media weight value table 400 includes a business section 410, a meeting section 420, a telephone section 430 and a mail section 440. The business section 410 stores the business. The meeting section 420 stores weight values in the case where the communication is the activity of meeting another person in charge. The telephone section 430 stores weight values in the case where the communication is the activity of using a telephone. The mail section 440 stores weight values in the case where the communication is the activity of using an electronic mail. The worker status determination module 115 acquires the weight values from the combination of the businesses and the kinds of activities using the media weight value table 400, and adds the weight values to the actual communication amount or subtracts the weight values from the actual communication amount. In an example of FIG. 4, in the case where the communication in the business A is the meeting, “5” is added to the actual communication amount or “5” is subtracted from the actual communication amount, while in the case where the communication in the business A is the electronic mail, “0.5” is added to the actual communication amount or “0.5” is subtracted from the actual communication amount. Since better communication is made in the case where the communication is the meeting, rather than in the case where the communication is the electronic mail, the actual communication amount is increased or decreased using the media weight value table 400. Also, a combination of an organization to which the person in charge belongs and the kinds of activities may be stored in correspondence to the weight values. Further, a combination of the business, the organization to which the person in charge belongs, and the kinds of activities may be stored in correspondence to the weight values.

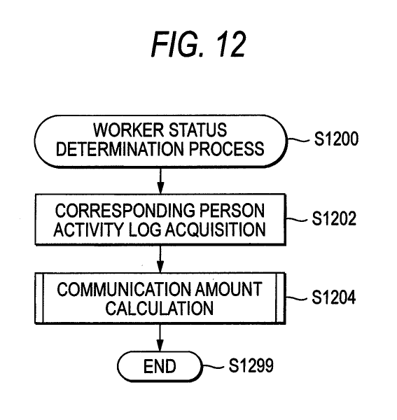

In this case, the processing of the worker status determination module 115 will be described later using a flowchart as exemplified in FIG. 12.

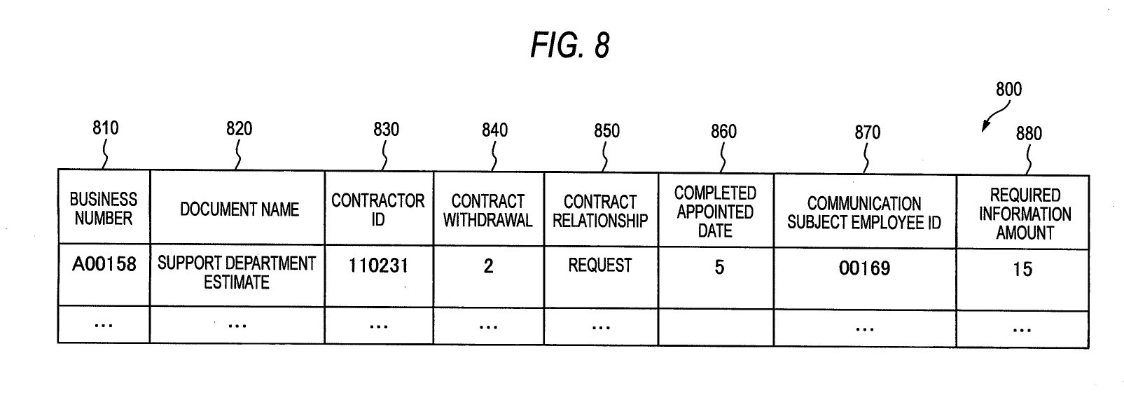

The guide condition data storage module 145 is connected to the trust amount determination module 125 and the guide correction module 190. The guide condition data storage module 145 stores guide condition data which is attribute information conveyance amount correspondence information that makes the attribute of the business and the communication amount required to perform the business correspond to each other. In this case, as the attribute of the business, for example, an attribute that indicates an experimental value of the person in charge may be included. As the guide condition data, for example, a guide condition data table 800 may be stored. FIG. 8 is an explanatory diagram illustrating an example of a data structure of a guide condition data table 800. The guide condition data table 800 includes a business number section 810, a document name section 820, a contractor ID section 830, a contract number section 840, a contract relationship section 850, a completed appointed date section 850, a communication subject employee ID section 870, and a required information amount section 880. The attribute of the business corresponds to the business number section 810, the document name section 820, the contractor ID section 830, the contract number section 840, the contract relationship section 850, the completed appointed date section 860, and the communication subject employee ID section 870. The required communication amount in the case of performing the business having the attribute corresponds to the required information amount section 880. The business number section 810 stores a business code (business number) that consistently identifies the business in an exemplary embodiment of the invention. The business that is indicated by the business code is a business that becomes the condition of presenting a guide. The document name section 820 stores the name of the document (for example, s supply department estimate) that is to be required in the business. The contractor ID section 830 stores a contractor code (contractor ID) that consistently identifies the contractor in the business in an exemplary embodiment of the invention. The contract number section 840 stores the number of contracts of the person in charge. This corresponds to the attribute that indicates the experimental value of the person in charge. The contract relationship section 850 stores the contract relationship in the business. The completed appointed date section 860 stores the completed appointed date of the business. The communication subject employee ID section 870 stores user information (for example, employee ID) that consistently identifies the user who is the subject of communication in an exemplary embodiment of the invention. The required information amount section 880 stores the communication amount that is required in the case where the business coincides with the conditions from the business number section 810 to the communication subject employee ID section 870.

In this case, the guide condition data storage module 145 may store two kinds of guide condition data tables 800 for regular business and irregular business.

The trust amount determination module 125 is connected to the regular/irregular determination module 110, the worker status determination module 115, the guide evaluation module 120, the output/notification module 130, and the guide condition data storage module 145. The trust amount determination module 125 extracts the communication amount that is required to perform the irregular business from the guide condition data table 800 stored in the guide condition data storage module 145 based on the attribute of the subject business if the business is determined to be the irregular business by the regular/irregular determination module 110. Also, the regular/irregular determination module 110 presents the guide information that is a guide required to perform the subject business to the user 199 through the output/notification module 130 by comparing the extracted required communication amount with the actual communication amount extracted by the worker status determination module 115. The generation of the guide information is perform in a manner that the comparison results and predetermined guide information are stored in correspondence to each other and the guide information is extracted based on the comparison results. For example, if the actual communication amount is smaller than the required communication amount, the actual communication amount is insufficient and a guide to the effect of pressing the communication is extracted, while if the actual communication amount is larger than the required communication amount, a guide to the effect of pressing the proceeding to the next business process (more specifically, for example, permission of printing of the document) is extracted.

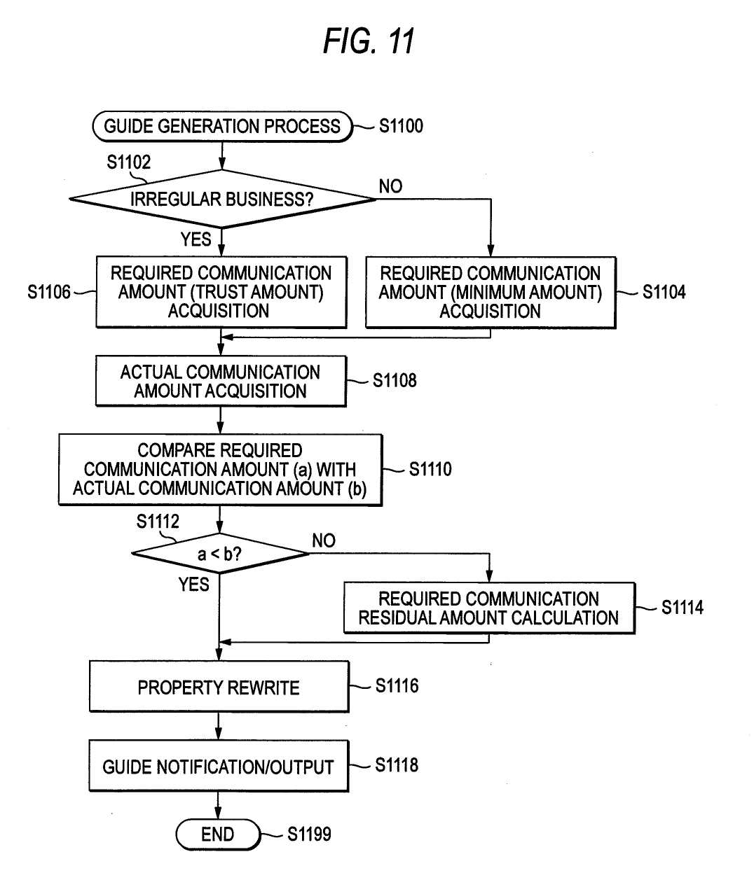

In this case, the processing of the trust amount determination module 125 will be described later using a flowchart as exemplified in FIG. 11.

The output/notification module 130 is connected to the trust amount determination module 125. The output/notification module 130 displays/notifies the guide information generated by the trust amount determination module 125 to the user 199. For example, the output/notification module 130 displays the guide information on a display device of an information processing apparatus (PC, portable information terminal, or the like) that the user 199 possesses.

The guide evaluation module 125 is connected to the trust amount determination module 125, the activity log data storage module 135, and the business flow data storage module 140. The guide evaluation module 120 changes the guide condition data that is the attribute information conveyance amount correspondence information stored in the guide condition data storage module 145 based on the actual communication amount extracted by the worker status determination module 115 in the case where the subject business is finished.

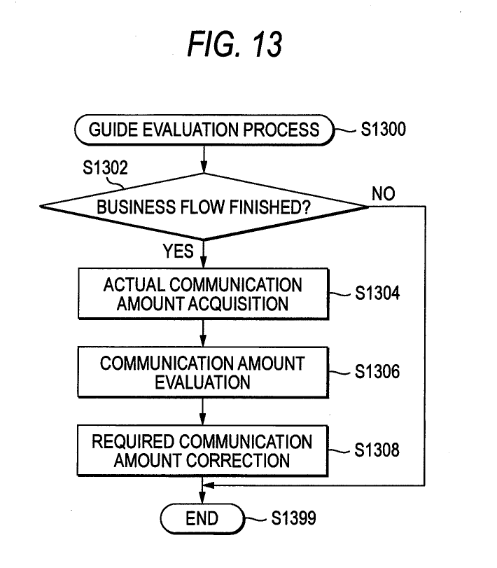

In this case, the processing of the guide evaluation module 120 will be described later using a flowchart as exemplified in FIG. 13.

The guide correction module 190 is connected to the guide condition data storage module 145. The guide correction module 190 notifies the person in charge who has performed the subject business so that the person in charge performs evaluation on the required communication amount if a difference between the actual communication amount extracted by the worker status determination module 115 and the required communication amount extracted by the trust amount determination module 125 is larger than a predetermined value in the case where the subject business is finished. Here, the evaluation is a so-called survey, which is to examine whether the required communication amount is appropriate.

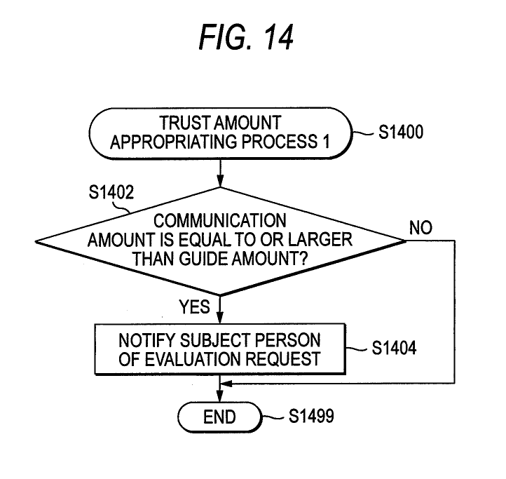

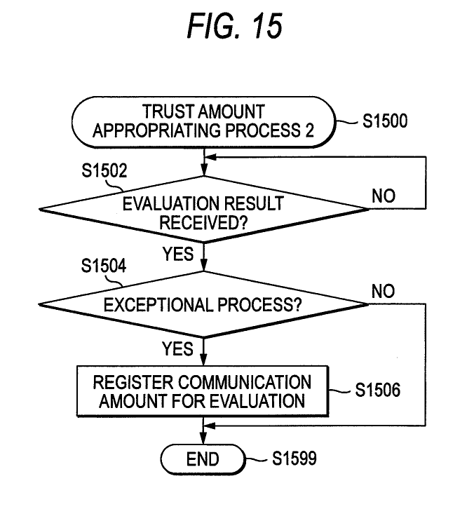

In this case, the processing of the guide correction module 190 will be described later using a flowchart exemplified in FIGS. 14 and 15.

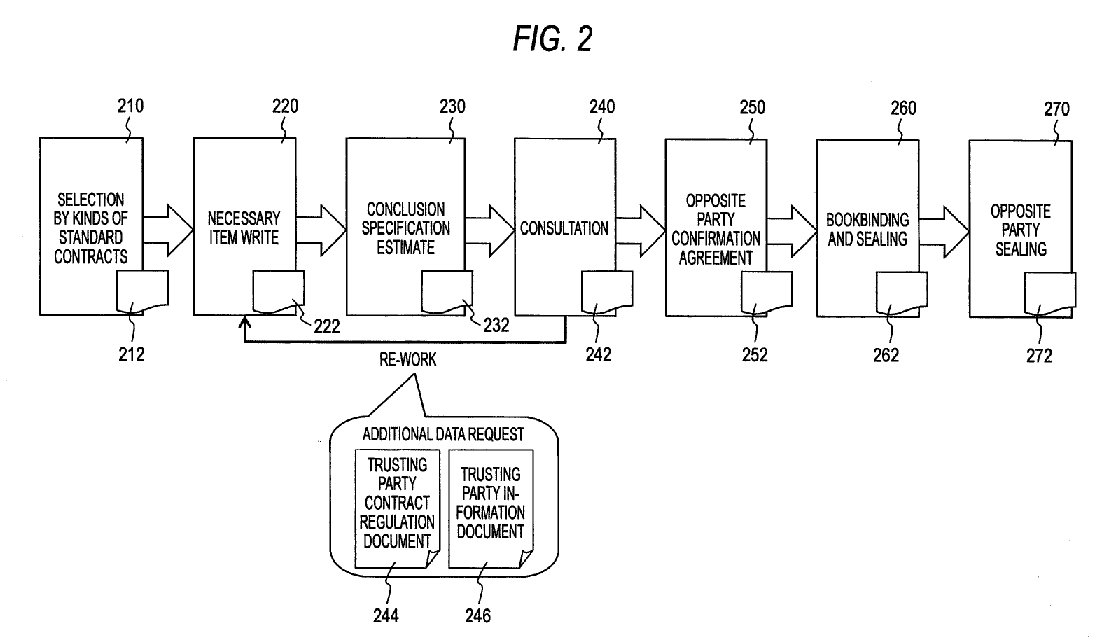

FIG. 2 is an explanatory diagram illustrating an example of a subject business flow according to an exemplary embodiment of the invention.

The business flow includes a plurality of businesses, and orders are given to the respective businesses. The business flow as exemplified in FIG. 2 is defined to sequentially perform a standard contract kind selection business 210, a required item write business 220, a transaction specification estimate business 230, a consultation business 240, an opposite party confirmation agreement business 250, a bookbinding/sealing business 260, and an opposite party sealing business 270. In this case, although the business flow exemplified in FIG. 2 is not divided, it may be a business flow that is divided from a main portion.

In the respective businesses, there are required documents that are handled in the respective businesses. For example, as a required document 212 of the standard contract kind selection business 210, there is a support department estimate (trader selection). As a required document 222, there is a support department estimate (trade selection) in which a contractor, a conclusion date, an amount of money, the appointed date, or the like. As a required document 232, there is a letter of transmittal, contract plan document, a confirmation item document, or the like. As a required document 242, there is an agreement contents confirmation replay document, a consultation, an estimate, a budget, or the like. As a required document 252, there is a consultation, an approval communication, or the like, As a required document 262, there is a contract, a seal request, a transmittal, or the like. As a required document 272, there is a contract, a copy, or the like.

The reception module 105 according to an exemplary embodiment of the invention receives the above-described document names or other document names except for the above-described document names by an operation of the person in charge. Also, the regular/irregular determination module 110 determines that the business is the regular business in the case of the above-described document names, and determines that the business is the irregular business in the case of the other document names except for the above-described document names. Also, the above-described document names are stored in a document name section 740 of the business flow data table 700 as exemplified in FIG. 7.

In the case of the business flow as exemplified in FIG. 2, if a business contract is made with an opposite party except for the customers which have continuously entrusted businesses, the person in charge has no contract experience, and thus there is a possibility that re-work (resuming of the work from the first) occurs, that is, a possibility that inquiries about the reason of selection, contract rules, and the like, occur in the consultation business 240 and additional submitted documents (entrusting party contract regulation document 244 and entrusting party information document 246) are increased. In an example of FIG. 2, re-work of two processes, which return from the consultation business 240 to the required item write business 220, occurs. Accordingly, in the case of receiving the document names in addition to the supply department estimate (trader selection) that describes a contractor, conclusion date, an amount of money, the appointed date, and the like, as the required document 222, a guide for advance confirmation and negotiation is generated and presented to a person in charge of the required item write business 220 by pressing communication with the person in charge of consultation of the consultation business 240.

In addition, as irregular business, for example, in a contract with the outside of the company, there is a contract conclusion business in the case where there is a difference between the contract regulations between the outside and the inside of the company, an approval business (that requires shortening of the lead time) which requires an emergency correspondence, or the like.

Here, the communication amount that is required to perform the business will be described.

First, it is assumed that the communication amount required to perform irregular business is a trust amount. That is, the trust amount is a communication amount that is required to supplement the irregular business in the case where the regular business becomes the irregular business, and means a threshold value at which the business flow does not re-work.

Although the trust amount is a predetermined value, it is a communication amount that is required to perform the business that is prescribed as the complexity of a business flow (including information on whether it is the standard flow, and if it is a contract, including contractor, contract number, contract relationship, and the like), participating department attribute, and the like.

Next, a method of setting a trust amount will be described in more detail.

In accordance with the complexity and contents of the subject business flow, the information amount that is required to proceed to the next business is determined. For example, the information amount is prescribed by the number of prepared documents, the amount of written contents, the number of approvers, and the like.

Here, the minimum amount will be described. The minimum amount is a communication amount for obtaining the information amount to be minimally satisfied in the case of performing the regular business.

Also, the communication amounts of the minimum amount and the trust amount are prescribed based on the resultant values in an example in which there is no re-work in the past regular and irregular businesses.

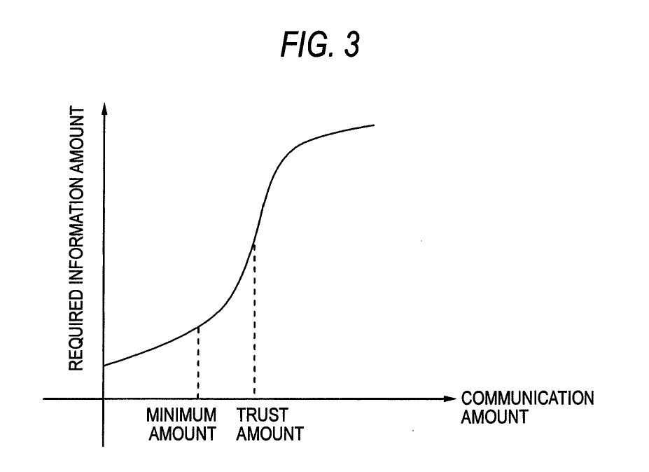

FIG. 3 is an explanatory diagram illustrating an example of the relationship between the minimum amount and the trust amount. Since the minimum amount corresponds to the regular business and the trust amount corresponds to the irregular business, the communication amount of the trust amount is larger than the communication amount of the minimum amount. Also, in the case of the irregular business, more information amount required to perform the business is required in comparison to the case of the regular business. The communication amount is indicated as an increasing function (if two real numbers a and b are in the relationship of a<b, the function f(x) is determined as f(a)<f(b).

Since the relationship between the trust amount and the minimum amount is changed by an individual experimental value (one of business attributes), the trust amount may be a value that is close to the minimum amount according to persons.

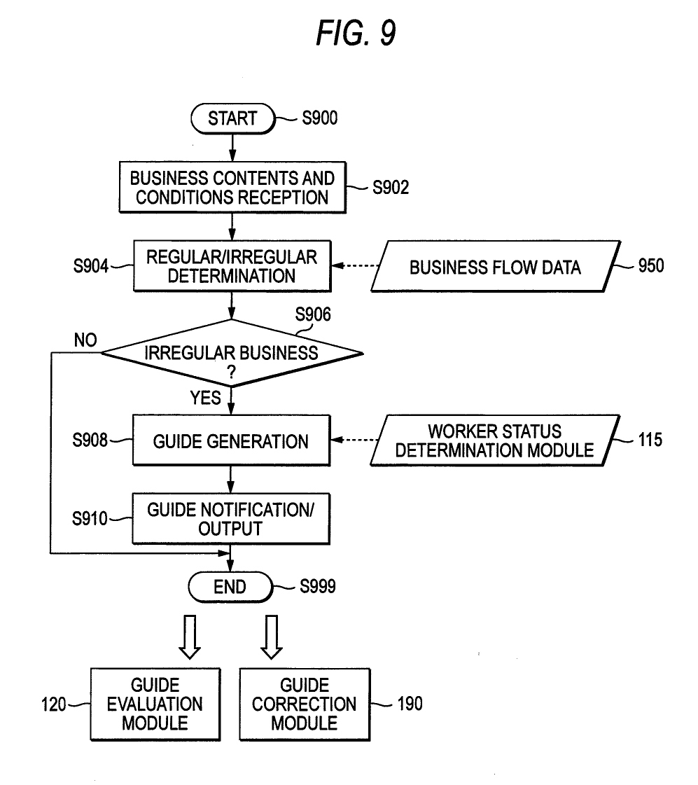

FIG. 9 is a flowchart illustrating a processing example according to an exemplary embodiment of the invention.

In step S902, the reception module 105 receives the business contents and conditions.

In step S904, the regular/irregular determination module 110 determines whether the subject business is the regular business or the irregular business by comparing the information received in step S902 with the business flow data 950 within the business flow data storage module 140. This will be described later using a flowchart exemplified in FIG. 10.

In step S906, the trust amount determination module 125 determines whether the result of determination corresponds to the irregular business, and in the case of the irregular business, the trust amount determination module 125 proceeds to step S908, while otherwise, it finishes the process (step S999).

In step S908, the trust amount determination module 125 generates a guide using the processing results by the worker status determination module 115. The processing of the worker status determination module 115 will be described later using a flowchart as exemplified in FIG. 12.

In step S910, the output/notification module 130 notifies and outputs the guide. The processing in steps S908 and S910 will be described later using the flowchart as exemplified in FIG. 11.

Also, after the business is finished, the processing by the guide evaluation module 120 or the processing by the guide correction module 190 is performed (this may also be the processing by the guide evaluation module 120 and the processing by the guide correction module 190). The processing by the guide evaluation module 120 will be described later using the flowchart as exemplified in FIG. 13. The processing by the guide correction module 190 will be described later using the flowchart as exemplified in FIGS. 14 and 15.

FIG. 10 is a flowchart illustrating a processing example by the regular/irregular determination module 110 according to an exemplary embodiment of the invention.

In step S1002, it is determined whether the business contents and conditions are received, and in the case where the business contents and conditions are received, the processing proceeds to step S1004, while otherwise, the processing is finished (step S1099).

In step S1004, the received business contents and the corresponding regular business are compared with each other. Specifically, for example, the received document name and the document name in the document name section 740 of the business flow data table 700 are compared with each other.

In step S1006, it is determined whether an item that is excluded from the regular range is received, and if the item is received, the processing proceeds to step S1008, while otherwise, the processing is finished (step S1099).

In step S1008, it is determined that the irregular business occurs in the process.

FIG. 11 is a flowchart illustrating a processing example by the trust amount determination module 125 according to an exemplary embodiment of the invention.

In step S1102, it is determined whether the business is the irregular business, and in the case of the irregular business, the processing proceeds to step S1106, while otherwise, the processing proceeds to step S1104.

In step S1104, the required communication amount (the minimum amount) is acquired from the guide condition data storage module 145. The required communication amount is acquired from the guide condition data table 800 for the regular business.

In step S1106, the required communication amount (trust amount) is acquired from the guide condition data storage module 145. The required communication amount is acquired from the guide condition data table 800 for the irregular business.

In step S1108, the actual communication amount is acquired from the worker status determination module 115.

In step S1110, the required communication amount (a) acquired in step S1104 or S1106 and the actual communication amount (b) acquired in step S1108 are compared with each other.

In step S1112, it is determined whether the condition of “required communication amount (a)<actual communication amount (b)” is satisfied, and if the condition is satisfied, the processing proceeds to step S1116, while otherwise, the processing proceeds to step S1114.

In step S1114, the residual amount of the required communication amount is calculated. That is, the communication amount that is required from now is calculated. Specifically, the residual amount becomes “required communication amount (a)−actual communication amount (b)”.

In step S1116, the property is rewritten. As the attribute of the business, the person in charge gives an attribute whether the activity in which the actual communication amount is larger than the required communication amount in the business is performed. Then, the person in charge in the next business may be referred to.

In step S1118, the output/notification module 130 notifies and outputs the guide. The trust amount determination module 125 generates the guide according to the result of determination in step S1112 and the result of calculation in step S1114.

FIG. 12 is a flowchart illustrating a processing example by the worker status determination module 115 according to an exemplary embodiment of the invention.

In step S1202, the activity log data of the corresponding person or the communication log data is acquired from the activity log data storage module 135.

In step S1204, the communication amount is calculated. The communication amount is calculated by converting the communication in the meeting, the communication in the electronic mail, and the like, which are included in the activity log data or the communication log data, into a common time index.

In this process, the calculation of the communication amount may be performed using the technique described in Patent Document 4. This technique is a technique that converts logs of respective communications performed by diverse communication means such as the electronic mail, telephone, direct dialogue, and the like, into an information acquisition time that is consumed in acquiring the communication information.

Here, the communication amount may be the number of transmission/reception of electronic mails or the like, the number of phone calls, a call time, the number of dialogues, a dialogue time, and the like. In addition, it is also possible to calculate the communication amount through the increase/decrease evaluation of the positive/negative keywords that uses the technique, such as a natural language process and the like, with respect to the texts used in the communication.

Also, in step S1204, as described above, the actual communication amount may be increased/decreased using the weight value of the media weight value table 400 as exemplified in FIG. 4.

FIG. 13 is a flowchart illustrating a processing example by the guide evaluation module 120. This is a process of reflecting the actual communication amount in the finished business in the required communication amount in the next business.

In step S1302, it is determined whether the business flow is finished, and if the business flow is finished, the processing proceeds to step S1304, while otherwise, the processing is finished (step S1399).

In step S1304, the actual communication amount generated in the business is acquired from the worker status determination module 115.

In step S1306, the evaluation is made by comparing the actual communication amount with the communication amount required in the business. For example, it is determined whether a difference between the communication amounts is larger than the predetermined value.

In step S1308, the communication amount required in the business is corrected. For example, if the difference is larger than the predetermined value, the correction is performed so that the required communication amount approximates to the actual communication amount. For example, the average value of the two communication amounts may be determined as the required communication amount, or a value that is obtained by multiplying the difference by a predetermined ratio may be added to or subtracted from the required communication amount.

Also, the equivalent correction may be performed with respect to not only the business but also the required communication amount of the business that is pre-related to the business.

FIG. 14 is a flowchart illustrating a processing example by the guide correction module 190 according to an exemplary embodiment of the invention. This process is performed in the case where the subject business is finished. This is to cope with the case where the required communication amount is unable to be corrected appropriately only by the processing in the flowchart as exemplified in FIG. 13.

In step S1402, it is determined whether the actual communication amount is equal to or larger than the required communication amount that is a guide amount, and if so, the processing proceeds to step S1404, while otherwise, the processing is finished (step S1499). It is determined whether the difference between the actual communication amount and the required communication amount is larger than a predetermined value. If the difference is larger than the predetermined value, the required communication amount may be inappropriate in the beginning.

In step S1404, an evaluation request is notified to the subject person. The subject person is the person in charge who performed the subject business. The subject person is notified so that he/she performs evaluation on the required communication mount. Here, the evaluation is, for example, a survey for verifying whether the required communication amount is appropriate. For example, the evaluation includes inquiries for determining whether the business is an exceptional business, whether the exceptional communication amount is generated, and the like.

FIG. 15 is a flowchart illustrating a processing example by the guide correction module 190 according to an exemplary embodiment of the invention. This process is performed after a plurality of evaluation results are collected by the processing in the flowchart as exemplified in FIG. 14.

In step S1502, it is determined whether the evaluation results are received, and if the evaluation results are received, the processing proceeds to step S1504, while otherwise, the step S1502 is performed again.

In step S1504, it is determined whether the business to be evaluated corresponds to an exceptional process, and if the business corresponds to the exceptional process, the processing proceeds to step S1506, while otherwise, the processing is finished (step S1599).

In step S1506, the required communication amount for evaluation is registered with respect to the exceptional business. That is, the exceptional business is considered as a new business, and the communication amount that is required for the business is registered.

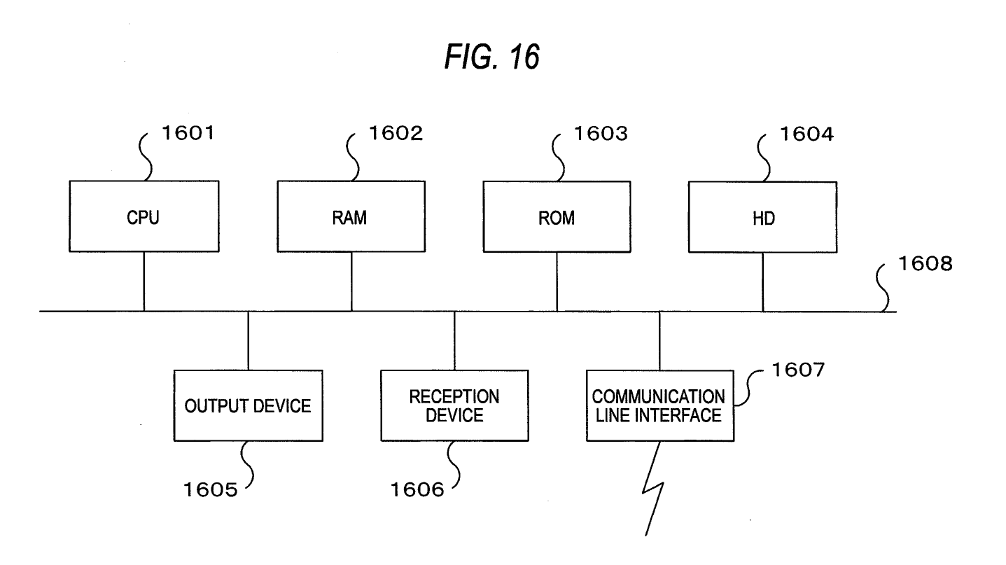

The hardware configuration of a computer in which a program according to an exemplary embodiment of the invention is, as exemplified in FIG. 16, a general computer, specifically, a personal computer, a computer that may serve as a server, or the like. That is, as a concrete example, a CPU 1601 is used as a processing unit (operation unit), and a RAM 1602, a ROM 1603, and an HD 1604 are used as storage devices. As the HD 1604, for example, a hard disk may be used. The hardware configuration includes the CPU 1601 that executes programs, such as the regular/irregular determination module 110, the worker status determination module 115, the guide evaluation module 120, the trust amount determination module 125, the guide correction module 190, and the like, a RAM 1602 storing programs or data, a ROM 1603 storing programs for starting the computer, an HD 1604 that is an auxiliary storage device, a reception device 1606 for receiving data based on the user's operation of a keyboard, a mouse, a touch panel, and the like, an output device 1605 such as a CRT or liquid crystal display, a communication line interface 1607 for connecting to a communication network such as a network interface card, and a bus 1608 for connecting these in order to exchange data among them. A plurality of computers may be connected through a network.

The above-described exemplary embodiment by the computer program may be realized in cooperation with software and hardware resources by making the system of the hardware configuration read the computer program that is software.

In this case, the hardware configuration illustrated in FIG. 16 represents one configuration example. An exemplary embodiment of the invention is not limited to the configuration illustrated in FIG. 16, and any configuration that executes the modules as explained in an exemplary embodiment of the invention may be used. For example, some modules may be configured by dedicated hardware (for example, ASIC and the like), or may be provided in an external system and be connected through communication lines. Further, a plurality of systems, as illustrated in FIG. 16, may be connected by communication lines to operate in cooperation with one another. Also, the configuration according to an exemplary embodiment of the invention may be assembled on an information home appliance, a copy machine, a facsimile, a printer, a multifunction peripheral (an image processing device having two or more functions of a scanner, a printer, a copy machine, a facsimile, and the like) in addition to the personal computer.

The above-described program may be stored in a recording medium to be provided or may be provided by a communication means. In this case, for example, the above-described program may be grasped as an invention of a “computer readable recording medium recorded with a program”.

The “computer readable recording medium recorded with a program” means a recording medium that is readable by a computer recorded with a program, which is used for program installation, execution, program distribution, and the like.

In this case, examples of recording media include “DVD-R, DVD-RW, DVD-RAM, and the like” which correspond to the standard appropriated in the DVD Forum as a digital versatile disc (DVD), “DVD+R, DVD+RW, and the like” which correspond to the standard appropriated in the DVD+RW, a read only memory (CD-ROM), a CD recordable (CD-R), a CD rewritable (CD-RW), and the like as compact disks (CD), a Blu-ray disc (registered trade name), an opto-magnetic disc (MO), a flexible disc (FD), a magnetic tape, a hard disk, a read only memory (ROM), an electrically erasable and programmable read only memory (EEPROM), a random access memory (RAM), and the like.

Also, the above-described programs or a portion thereof may be recorded in the recording medium for preservation or distribution. Also, the programs or a portion thereof may be transmitted by communication, for example, using a transmission media such as a wired network that is used in a local area network (LAN), a metropolitan area network (MAN), a wide area network (WAN), the Internet, an intranet, an extranet, and the like, a wireless communication network, or a combination thereof, or may be carried on carrier waves.

Also, the above-described program may be a portion of another program, or may be recorded in a recording medium together with a separate program. Also, the program may be separately recorded in a plurality of recording media. Also, if the program may be compressed, encrypted, or restored, it may be recorded in any type.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### DESCRIPTION OF REFERENCE NUMERALS AND SIGNS

105: reception module

110: regular/irregular determination unit

115: worker status determination module

120: guide evaluation module

125: trust amount determination module

130: output/notification module

135: activity log data storage module

140: business flow data storage module

145: guide condition data storage module

190: guide correction module

199: user

What is claimed is:

1. An information processing apparatus comprising:
a reception module that receives business contents of a subject business;
a determination module that determines whether the subject business is irregular business by comparing the business contents received by the reception module with a predetermined regular business contents;
a required information conveyance amount extraction module that extracts a required information conveyance amount required to perform the irregular business from attribute information conveyance amount correspondence information, in which an attribute of the subject business and the required information conveyance amount are stored in correspondence to each other, based on the attribute of the subject business when it is determined by the determination module that the business contents is the irregular business;
an actual information conveyance amount extraction module that extracts an actual information conveyance amount of a person in charge who performs the subject business based on activity information that is a record of activities of the person in charge; and
a presentation module that presents guidance which is required to perform the subject business by comparing the required information conveyance amount extracted by the required information conveyance amount extraction module with the actual information conveyance amount extracted by the actual information conveyance amount extraction module.

2. The information processing apparatus according to claim 1, wherein the actual information conveyance amount extraction module increases or decreases the actual information conveyance amount in accordance with the kind of activities of the person in charge.

3. The information processing apparatus according to claim 1, further comprising a change module that change the attribute information conveyance amount correspondence information based on the actual information conveyance amount extracted by the actual information conveyance amount extraction module when the subject business is finished.

4. The information processing apparatus according to claim 2, further comprising a change module that change the attribute information conveyance amount correspondence information based on the actual information conveyance amount extracted by the actual information conveyance amount extraction module when the subject business is finished.

5. The information processing apparatus according to claim 1, further comprising a notification module that notifies the person in charge who has performed the subject business so that the person in charge performs evaluation on the required information conveyance amount when a difference between the actual information conveyance amount extracted by the actual information conveyance amount extraction module and the required information conveyance amount extracted by the required information conveyance amount extraction module is larger than a given threshold value in case where the subject business is finished.

6. The information processing apparatus according to claim 2, further comprising a notification module that notifies the person in charge who has performed the subject business so that the person in charge performs evaluation on the required information conveyance amount when a difference between the actual information conveyance amount extracted by the actual information conveyance amount extraction module and the required information conveyance amount extracted by the required information conveyance amount extraction module is larger than a given threshold value in case where the subject business is finished.

7. The information processing apparatus according to claim 3, further comprising a notification module that notifies the person in charge who has performed the subject business so that the person in charge performs evaluation on the required information conveyance amount when a difference between the actual information conveyance amount extracted by the actual information conveyance amount extraction module and the required information conveyance amount extracted by the required information conveyance amount extraction module is larger than a given threshold value in case where the subject business is finished.

8. The information processing apparatus according to claim 4, further comprising a notification module that notifies the person in charge who has performed the subject business so that the person in charge performs evaluation on the required information conveyance amount when a difference between the actual information conveyance amount extracted by the actual information conveyance amount extraction module and the required information conveyance amount extracted by the required information conveyance amount extraction module is larger than a given threshold value in case where the subject business is finished.

9. An information processing method comprising:
receiving business contents of a subject business;
determining whether the subject business is irregular business by comparing the received business contents with a predetermined regular business contents;
extracting a required information conveyance amount required to perform the irregular business from attribute information conveyance amount correspondence information, in which an attribute of the subject business and the required information conveyance amount are stored in correspondence to each other, based on the attribute of the subject business when it is determined in the determination step that the business contents is the irregular business;
extracting an actual information conveyance amount of a person in charge who performs the subject business based on activity information that is a record of activities of the person in charge; and
presenting guidance which is required to perform the subject business by comparing the required information conveyance amount with the actual information conveyance amount.

10. A computer readable medium storing a program causing a computer to perform a process for information processing, the process comprising:
receiving business contents of a subject business;
determining whether the subject business is irregular business by comparing the received business contents with a predetermined regular business contents;
extracting a required information conveyance amount required to perform the irregular business from attribute information conveyance amount correspondence information, in which an attribute of the subject business and the required information conveyance amount are stored in correspondence to each other, based on the attribute of the subject business when it is determined in the determination step that the business contents is the irregular business;
extracting an actual information conveyance amount of a person in charge who performs the subject business based on activity information that is a record of activities of the person in charge; and
presenting guidance which is required to perform the subject business by comparing the required information conveyance amount with the actual information conveyance amount.
